(19) United States
(12) Patent Application Publication
(10) Pub. No.: US 2023/0390153 A1
(43) Pub. Date: Dec. 7, 2023

(54) HYDROGEN GENERATIION AND DELIVERY DEVICE AND METHODS

(71) Applicants: Zhaoyang Li, San Jose, CA (US); Zhaoqin Li, Longyan (CN)

(72) Inventors: Zhaoyang Li, San Jose, CA (US); Zhaoqin Li, Longyan (CN)

(21) Appl. No.: 17/831,447

(22) Filed: Jun. 3, 2022

(51) Int. Cl. A61H 33/14; C01B 3/08; A61H 33/02

(52) U.S. Cl. CPC A61H 33/14; C01B 3/08; A61H 33/028; A61H 2033/148

(57) ABSTRACT

The present disclosure provides a hydrogen generation and dispersion device and methods of making and using the same.

### FIELD OF THE INVENTION

The present invention relates to a home hydrogen generation and delivery device and methods.

### BACKGROUND OF THE INVENTION

Bathing in hydrogen infused or saturated water has been proven to be beneficial to skin and skeletal conditions such as psoriasis and osteoarthritis. see, e.g., Tarnava, A. (2021). Supersaturated Hydrogen-Rich Water Hydrotherapy for Recovery of Acute Injury to the Proximal Phalanges on the 5th Toe: A Case Report. Journal of Science and Medicine; 3(1); Zhu, Q., Wu, Y., Li, Y. et al. Positive effects of hydrogen-water bathing in patients of psoriasis and parapsoriasis en plaques. Sci Rep 8, 8051 (2018). Home use of hydrogen enriched water for bathing, however, is challenging due to risk exposure of hydrogen gas, e.g., explosion risk in the case of using a hydrogen tank and electroshock and explosion risks in the case of using hydrogen generated by electrolysis.

Hydrogen tablets are developed and commercially available for generation of hydrogen enriched water for drinking. Such a form of hydrogen is also not useable for bathing water as bathing water requires gallons of water. Additionally, bathing generally takes time, for example, 10 minutes to 30 minutes, and it would be desirable to keep the hydrogen concentration level relatively stable. As hydrogen is a highly effusive and evaporative gas, and hydrogen tablets generally releases hydrogen in a minute or two, it is undesirable to use hydrogen tablets for bathing.

As such, there is a need for a device for home use that is capable of generating and delivering hydrogen for bathing that does not use hydrogen tank nor electrolysis.

The embodiments provided below address the above identified issues and needs.

### SUMMARY OF THE INVENTION

In one aspect of the present disclosure, it is provided a hydrogen generation and dispersion device, comprising:
a hydrogen generation body, and
a hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

In some embodiments of the disclosed device, optionally in combination with one or more disclosed embodiments herein, the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

In some embodiments of the disclosed device, optionally in combination with one or more disclosed embodiments herein, the gas disperser comprises porous gas outlets.

In some embodiments of the disclosed device, optionally in combination with one or more disclosed embodiments herein, the hydrogen generation composition comprises an acid and a metal agent capable of reacting with the acid to generate hydrogen gas.

In some embodiments of the disclosed device, optionally in combination with one or more disclosed embodiments herein, the enclosure is made of a plastic material, a ceramic material, glass, or metallic material.

In some embodiments of the disclosed device, optionally in combination with one or more disclosed embodiments herein, the gas-dispersion tube is a plastic tube.

In some embodiments of the disclosed device, optionally in combination with one or more disclosed embodiments herein, the acid is a non-volatile acid.

In some embodiments of the disclosed device, optionally in combination with one or more disclosed embodiments herein, the metal comprises magnesium particles.

In another aspect of the present disclosure, it is provided a method of fabrication, comprising:
providing a hydrogen generation body,
providing a hydrogen dispersion assembly, and
forming a hydrogen generation and dispersion device comprising the hydrogen generation body and the hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

In some embodiments of the disclosed method, optionally in combination with one or more disclosed embodiments herein, the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

In some embodiments of the disclosed method, optionally in combination with one or more disclosed embodiments herein, the gas disperser comprises porous gas outlets.

In some embodiments of the disclosed method, optionally in combination with one or more disclosed embodiments herein, the hydrogen generation composition comprises an acid and a metal agent capable of reacting with the acid to generate hydrogen gas.

In some embodiments of the disclosed method, optionally in combination with one or more disclosed embodiments herein, the enclosure is made of a plastic material, a ceramic material, glass, or metallic material.

In some embodiments of the disclosed method, optionally in combination with one or more disclosed embodiments herein, the gas-dispersion tube is a plastic tube.

In some embodiments of the disclosed method, optionally in combination with one or more disclosed embodiments herein, the acid is a non-volatile acid.

In some embodiments of the disclosed method, optionally in combination with one or more disclosed embodiments herein, the metal comprises magnesium particles.

In a further aspect of the present disclosure, it is provided a method, comprising generating and dispersing hydrogen in a volume of bathing water through a hydrogen generation and dispersion device, and causing a user in need thereof to bath in the volume of bathing water, wherein hydrogen generation and dispersion device comprises:
a hydrogen generation body, and
a hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

In some embodiments of the disclosed method, optionally in combination with one or more disclosed embodiments herein, the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

In some embodiments of the disclosed method, optionally in combination with one or more disclosed embodiments herein, the gas disperser comprises porous gas outlets.

In some embodiments of the disclosed method, optionally in combination with one or more disclosed embodiments herein, the hydrogen generation composition comprises an acid and a metal agent capable of reacting with the acid to generate hydrogen gas.

In some embodiments of the disclosed method, optionally in combination with one or more disclosed embodiments herein, the enclosure is made of a plastic material, a ceramic material, glass, or metallic material.

In some embodiments of the disclosed method, optionally in combination with one or more disclosed embodiments herein, the gas-dispersion tube is a plastic tube.

In some embodiments of the disclosed method, optionally in combination with one or more disclosed embodiments herein, the acid is a non-volatile acid.

In some embodiments of the disclosed method, optionally in combination with one or more disclosed embodiments herein, the metal comprises magnesium particles.

In some embodiments of the disclosed method, optionally in combination with one or more disclosed embodiments herein, the generating and dispersing hydrogen is made and maintained continuously for a period between 5 minutes to 60 minutes.

In some embodiments of the disclosed method, optionally in combination with one or more disclosed embodiments herein, the user has a medical condition or a cosmetical condition.

In some embodiments of the disclosed method, optionally in combination with one or more disclosed embodiments herein, the user is a COVID-19 patient.

In some embodiments of the disclosed method, optionally in combination with one or more disclosed embodiments herein, the user is a long COVID-19 patient.

### BRIEF DESCRIPTION OF THE DRAWINGS

FIG. 1A and FIG. 1B show an embodiment of a hydrogen generation and dispersion device of disclosure.

FIG. 2 shows an embodiment of use of hydrogen generation and dispersion device of disclosure.

### DETAILED DESCRIPTION OF THE INVENTION

### Definitions

As used herein, if applicable, all percentages are by weight (wt %) of the total composition. All numeric ranges are inclusive of narrower ranges; delineated upper and lower range limits are interchangeable to create further ranges not explicitly delineated. All ranges and values disclosed herein are inclusive and combinable. For examples, any value or point described herein that falls within a range described herein can serve as a minimum or maximum value to derive a sub-range, etc.

As used herein, the term “bathing” refers to submerge a substantial part of the body of a user in a volume of water in a container, e.g., a bathtub. Depending the amount of water in the tub, a user can have his/her whole body below neck in the water. Sometimes, a user can have his/her whole body in the water.

As used herein, the term “in need thereof” refers to having a cosmetic or medical condition that can be treated or alleviated by molecular hydrogen. As used herein, molecular hydrogen refers to hydrogen in its molecular form, H₂. Molecular hydrogen is also commonly referred to as hydrogen gas or H₂ gas.

As used herein, the terms “comprising,” “having,” and “including” are used in their open, non-limiting sense.

The terms “a,” “an,” and “the” are understood to encompass the plural as well as the singular.

The expression “at least one” means “one or more” (and vice versa) and thus includes individual components as well as mixtures/combinations.

“Film former” or “film forming agent” as used herein means a polymer or resin that leaves a film on the substrate to which it is applied, for example, after a solvent accompanying the film former has evaporated, absorbed into and/or dissipated on the substrate.

Whenever used, the term “metal agent” refers to a metal agent for capable of having a reaction with an acid disclosed herein to generate hydrogen gas. In some embodiments, the metal agent comprises magnesium or aluminum, optionally Fe. Generally, such reaction is undertaken with the acid in a liquid state. The liquid state can be a solution of the acid, for example, an aqueous solution of the acid. In some embodiments, the solution can be a non-aqueous solution of the acid. The acid can be volatile and non-volatile acid, and can be any organic or inorganic acid. e.g., phosphoric acid, NaH₂PO₄, maleic acid, acetic acid, or citric acid.

### Hydrogen Generation and Dispersion Device

In one aspect of the present disclosure, it is provided a hydrogen generation and dispersion device, comprising:
a hydrogen generation body, and
a hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

In some embodiments of the disclosed device, optionally in combination with one or more disclosed embodiments herein, the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

In some embodiments of the disclosed device, optionally in combination with one or more disclosed embodiments herein, the gas disperser comprises porous gas outlets.

In some embodiments of the disclosed device, optionally in combination with one or more disclosed embodiments herein, the hydrogen generation composition comprises an acid and a metal agent capable of reacting with the acid to generate hydrogen gas.

In some embodiments of the disclosed device, optionally in combination with one or more disclosed embodiments herein, the enclosure is made of a plastic material, a ceramic material, glass, or metallic material.

In some embodiments of the disclosed device, optionally in combination with one or more disclosed embodiments herein, the gas-dispersion tube is a plastic tube.

In some embodiments of the disclosed device, optionally in combination with one or more disclosed embodiments herein, the acid is a non-volatile acid. In some other embodiments, the acid is a volatile acid, e.g., acetic acid.

In some embodiments of the disclosed device, optionally in combination with one or more disclosed embodiments herein, the metal comprises magnesium particles.

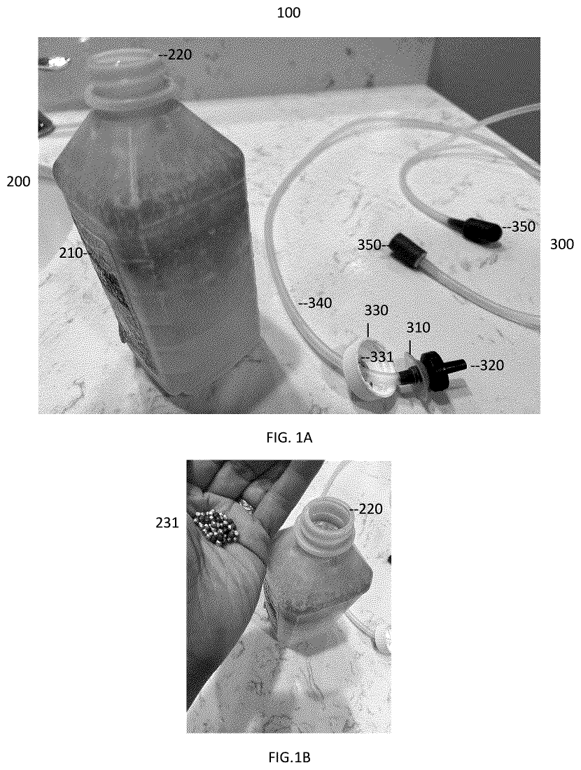

FIG. 1A and FIG. 1B show an embodiment of the disclosed device, which is described in detail in Example 1.

Molecular hydrogen, the smallest molecule, has excellent skin permeability and tissue diffusivity (see, e.g., Yamamoto, Ryo et al. “Hydrogen gas distribution in organs after inhalation: Real-time monitoring of tissue hydrogen concentration in rat.” Scientific reports vol. 9, 1 1255. 4 Feb. 2019).

### Methods of Fabrication

In another aspect of the present disclosure, it is provided a method of fabrication, comprising:
providing a hydrogen generation body,
providing a hydrogen dispersion assembly, and
forming a hydrogen generation and dispersion device comprising the hydrogen generation body and the hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

In some embodiments of the disclosed method, optionally in combination with one or more disclosed embodiments herein, the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

In some embodiments of the disclosed method, optionally in combination with one or more disclosed embodiments herein, the gas disperser comprises porous gas outlets.

In some embodiments of the disclosed method, optionally in combination with one or more disclosed embodiments herein, the hydrogen generation composition comprises an acid and a metal agent capable of reacting with the acid to generate hydrogen gas.

In some embodiments of the disclosed method, optionally in combination with one or more disclosed embodiments herein, the enclosure is made of a plastic material, a ceramic material, glass, or metallic material.

In some embodiments of the disclosed method, optionally in combination with one or more disclosed embodiments herein, the gas-dispersion tube is a plastic tube.

In some embodiments of the disclosed method, optionally in combination with one or more disclosed embodiments herein, the acid is a non-volatile acid. In some other embodiments, the acid is a volatile acid, e.g., acetic acid.

In some embodiments of the disclosed method, optionally in combination with one or more disclosed embodiments herein, the metal comprises magnesium particles.

FIG. 1A and FIG. 1B show an embodiment of the disclosed device fabricated according to an embodiment of the method disclosed herein.

### Method of Use

In a further aspect of the present disclosure, it is provided a method, comprising generating and dispersing hydrogen in a volume of bathing water through a hydrogen generation and dispersion device, and causing a user in need thereof to bath in the volume of bathing water, wherein hydrogen generation and dispersion device comprises:
a hydrogen generation body, and
a hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

In some embodiments of the disclosed method, optionally in combination with one or more disclosed embodiments herein, the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

In some embodiments of the disclosed method, optionally in combination with one or more disclosed embodiments herein, the gas disperser comprises porous gas outlets.

In some embodiments of the disclosed method, optionally in combination with one or more disclosed embodiments herein, the hydrogen generation composition comprises an acid and a metal agent capable of reacting with the acid to generate hydrogen gas.

In some embodiments of the disclosed method, optionally in combination with one or more disclosed embodiments herein, the enclosure is made of a plastic material, a ceramic material, glass, or metallic material.

In some embodiments of the disclosed method, optionally in combination with one or more disclosed embodiments herein, the gas-dispersion tube is a plastic tube.

In some embodiments of the disclosed method, optionally in combination with one or more disclosed embodiments herein, the acid is a non-volatile acid or volatile acid.

In some embodiments of the disclosed method, optionally in combination with one or more disclosed embodiments herein, the metal comprises magnesium particles.

In some embodiments of the disclosed method, optionally in combination with one or more disclosed embodiments herein, the generating and dispersing hydrogen is made and maintained continuously for a period between 5 minutes to 60 minutes.

In some embodiments of the disclosed method, optionally in combination with one or more disclosed embodiments herein, the user has a medical condition or a cosmetical condition.

In some embodiments of the disclosed method, optionally in combination with one or more disclosed embodiments herein, the user is a COVID-19 patient.

In some embodiments of the disclosed method, optionally in combination with one or more disclosed embodiments herein, the user is a long COVID-19 patient.

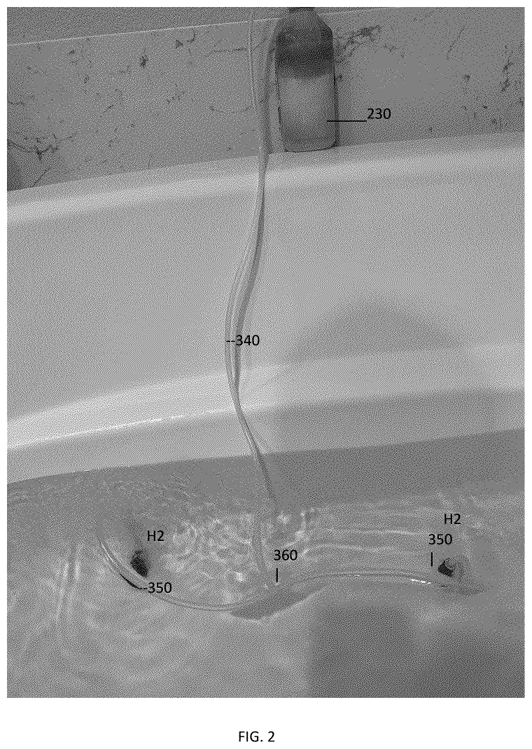

FIG. 2 shows a method of using the disclosed device.

### Method of Medical or Cosmetic Use

In some embodiments, the disclosed device can be used to treat or alleviate a cosmetical or medical condition of a user. A user of the disclosed device can have a condition that can be treated or alleviated by molecular hydrogen. Such conditions are, for example, a skin condition, such as psoriasis, a bone condition, such as osteoporosis, arthritis (rheumatic arthritis or osteoarthritis), obesity, diabetic ulcers, psoriasis, conditions in organs such as heart, kidney, nervous system, cardiovascular system. It is documented that Hydrogen may be used to protect multiple organs including the heart, kidney, and nervous system via anti-apoptotic and anti-oxidative functions to maintain the normal response of the body and reduce mortality (Hayashida et al., 2012; Hayashida et al., 2014; Homma et al., 2014).

In another embodiment, the disclosed device herein can be used to alleviate symptoms of long COVID-19. It is also well documented that molecular hydrogen is effective as an adjuvant therapy for COVID-19. See, e.g., Yang F, Yue R, Luo X, Liu R. and Huang X (2020) Hydrogen: A Potential New Adjuvant Therapy for COVID-19 Patients, Front. Pharmacol. 11:543718. In particular, the use of hydrogen might reduce the destructive cytokine storm and lung injury caused by SARS-CoV-2 during COVID-19 (Corona Virus Disease 2019) in the early stage, stimulating ropy sputum drainage, and ultimately reducing the incidence of severe disease, including cytokine storm, oxidative stress reactions in COVID-10 patients, and COVID-19 related viscous secretions. Id.

In some embodiments, a disclosed device can be used to disperse hydrogen in a volume of bathing water that includes another cosmetic or therapeutic agent, such as, e.g., an essence oil, or a vitamin.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls. The foregoing description illustrates and describes the disclosure. Additionally, the disclosure shows and describes only the exemplary embodiments but, as mentioned above, it is to be understood that it is capable to use in various other combinations, modifications, and environments and is capable of changes or modifications within the scope of the disclosed concepts as expressed herein, commensurate with the above teachings and/or the skill or knowledge of the relevant art. The embodiments described herein above are further intended to explain best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended to the appended claims be construed to include alternative embodiments.

### EXAMPLES

The examples below further illustrate, and shall not be construed to limit, the scope of present invention.

### Example 1. Hydrogen Generation and Dispersion Device

FIG. 1A, 1B and FIG. 2 show an embodiment of the hydrogen generation and dispersion device of the present disclosure that was designed and made according to the disclosure herein. Referring to FIG. 1A, a hydrogen generation and dispersion device, 100, is shown to have a hydrogen generation body 200 and a hydrogen dispersion assembly 300. The hydrogen generation body 200 has an enclosure 210, which includes an opening 220. A hydrogen generation composition 230 is included in the enclosure 210. The hydrogen dispersion assembly 300 includes a seal 310, a one-way valve 320, a cap, 330, having a hole, 331, in the middle of cap 330, the one-way valve 320 is configured to connect with a tube, 340, via the hole 331. The tube 340 has more two gas dispersers, 350, attached thereto via a “T” three-way connector, 360 (shown in FIG. 2). Optionally, a single gas disperser, 350, can be attached to tube 340 directly. Further, more than one “T” connectors, e.g., two “T” connectors 360 can be used to attach multiple gas dispersers 350.

### Examples 2-4. Use of Hydrogen Generation and Dispersion Device

Hydrogen gas is made and dispersed in a volume of tub water using the device of Example 1. The hydrogen generation composition 230 was made to include an acid (not shown), which is phosphoric acid (Example 2), citric acid (Example 3), or acetic acid (Example 4). In all Examples 3-4, metal agent, 231, (shown in FIG. 1B), is magnesium particles.

User, a male in late 50's, had dry-skin itching condition. He bathed in the hydrogen enriched water according to above since Nov. 1, 2021. The itching on his skin disappeared after one bathing and did not return during the 2021-2022 winter season. He continues to bathing in the hydrogen enriched water.

### SUMMARY

The disclosed hydrogen generation and dispersion device provides a safe and convenient hydrogen source for everyday home use, which is presently unavailable. Given that molecular hydrogen has broad applications in cosmetic and medical uses, particularly as an adjuvant therapy in known medical conditions and emerging conditions associated with COVID-19, the advantages of the present disclosure are evident and are cosmetically and medically significant.

It is understood that the foregoing detailed description and the following examples are illustrative only and are not to be taken as limitations upon the scope of the invention. Various changes and modifications to the disclosed embodiments, which will be apparent to those of skill in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

The following examples illustrate rather than limit the embodiments of the present invention.

Those skilled in the art will know, or be able to ascertain, using no more than routine experimentation, many equivalents to the specific embodiments of the invention described herein. These and all other equivalents are intended to be encompassed by the following claims.

We claim:

1. A hydrogen generation and dispersion device, comprising:
a hydrogen generation body, and
a hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

2. The hydrogen generation and dispersion device according to claim 1, wherein the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

3. The hydrogen generation and dispersion device according to claim 1, wherein the gas disperser comprises porous gas outlets.

4. The hydrogen generation and dispersion device according to claim 1, wherein the hydrogen generation composition comprises an acid and a metal agent capable of reacting with the acid to generate hydrogen gas.

5. The hydrogen generation and dispersion device according to claim 1, wherein the enclosure is made of a plastic material, a ceramic material, glass, or metallic material, and wherein the gas-dispersion tube is a plastic tube.

6. The hydrogen generation and dispersion device according to claim 4, wherein the acid is a non-volatile acid or volatile acid.

7. The hydrogen generation and dispersion device according to claim 4, wherein the metal agent comprises magnesium particles.

8. A method, comprising generating and dispersing hydrogen in a volume of bathing water through a hydrogen generation and dispersion device, and causing a user in need thereof to bath in the volume of bathing water, wherein hydrogen generation and dispersion device comprises:
a hydrogen generation body, and
a hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

9. The method according to claim 8, wherein the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.

10. The method according to claim 8, wherein the gas disperser comprises porous gas outlets.

11. The method according to claim 8, wherein the hydrogen generation composition comprises an acid and a metal agent capable of reacting with the acid to generate hydrogen gas.

12. The method according to claim 8, wherein the enclosure is made of a plastic material, a ceramic material, glass, or metallic material, and
wherein the gas-dispersion tube is a plastic tube.

13. The method according to claim 11, wherein the acid is a non-volatile acid.

14. The method according to claim 11, wherein the metal agent comprises magnesium particles.

15. The method according to claim 8, wherein generating and dispersing hydrogen is made and maintained continuously for a period between 5 minutes to 60 minutes.

16. The method according to claim 8, wherein the user has a medical condition or a cosmetical condition.

17. The method according to claim 8, wherein user is a COVID-19 patient.

18. The method according to claim 8, wherein the user is a long COVID-19 patient.

19. A method of fabrication, comprising:
providing a hydrogen generation body,
providing a hydrogen dispersion assembly, and
forming a hydrogen generation and dispersion device comprising the hydrogen generation body and the hydrogen dispersion assembly,
wherein the hydrogen generation body comprises an enclosure holding a hydrogen generation composition, the enclosure having an opening configured to connect to the hydrogen dispersion assembly, and
wherein the gas dispersion assembly comprises one or more gas disperser.

20. The method according to claim 19, wherein the gas dispersion assembly further comprises a seal, a one-way valve, a cap, and a gas-dispersion tube, the one-way valve being configured to open under a pressure within the enclosure and to connect to a gas-dispersion tube, the cap being configured to connect to the opening of the enclosure.
